(19) United States
(12) Patent Application Publication
(10) Pub. No.: US 2022/0301028 A1
(43) Pub. Date: Sep. 22, 2022

(54) AGGREGATION AND SEARCH FOR INTERNET PORTALS

(71) Applicant: CouponCabin, LLC, Chicago, IL (US)

(72) Inventors: Scott KLUTH, Chicago, IL (US); Steve Holland, Chicago, IL (US)

(21) Appl. No.: 17/208,863

(22) Filed: Mar. 22, 2021

(51) Int. Cl. G06Q 30/06; G06F 16/955; G06Q 30/02; H04L 29/08

(52) U.S. Cl. CPC G06Q 30/0605; G06F 16/955; G06Q 30/0201; G06Q 30/0222; H04L 67/14

(57) ABSTRACT

Techniques for network portal search and aggregation. A merchant is identified based on a request received from a communication device associated with a user. A communication network is searched for portals relating to the identified merchant, and a plurality of portals are identified. A first portal is selected, from the plurality of portals. A server initiates, using a computer processor, a session with the first portal. This includes transmitting to the first portal one or more aggregate identifiers that identify both the user and the server. It is determined that the user is entitled to a fulfillment based on the user completing a transaction with the merchant using the first portal. The fulfillment is provided to the user.

### TECHNICAL FIELD

Embodiments presented in this disclosure generally relate to network communications. More specifically, one or more embodiments disclosed herein relate to internet portal search and aggregation.

### BACKGROUND

Many merchants offer goods and services for sale via communication networks, like the Internet, through purchase environments that are presented to consumers on websites, mobile applications, and other electronically-connected purchase environments. Other entities offer benefits and promotions to customers of these merchants through portals. For example, portals may offer customers a promotional benefit (e.g., “10% cash back”) for purchases made from a merchant via the portal. A customer can sign up for an account with the portal, make a purchase at the merchant using the portal, and then receive the offered benefit (e.g., cash back) after the purchase.

This offers numerous advantages to both customers and merchants. Customers receive promotions and discounts, and can receive cash back and other benefits (e.g., airline miles, hotel points, credit card points, discounts, club memberships, or other benefits). Merchants, meanwhile, receive advertising and increased sales from customers driven to the merchants' purchase environments by the portal.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a communication network with portal search and aggregation, according to one embodiment.

FIG. 2 is a block diagram illustrating an aggregation server for portal search and aggregation, according to one embodiment.

FIG. 3 is a message diagram for portal search and aggregation, according to one embodiment.

FIG. 4 is a flowchart illustrating portal search and aggregation, according to one embodiment.

FIG. 5 is a flowchart illustrating identifying portals for portal search and aggregation, according to one embodiment.

FIG. 6 is a flowchart illustrating triggering fulfillment for portal search and aggregation, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

Embodiments include a method. The method includes identifying a merchant based on a request received from a communication device associated with a user. The method further includes searching in a communication network for portals relating to the identified merchant and identifying a plurality of portals. The method further includes selecting a first portal, from the plurality of portals. The method further includes initiating, by a server using a computer processor, a session with the first portal, including transmitting to the first portal one or more aggregate identifiers that identify both the user and the server. The method further includes determining that the user is entitled to a fulfillment based on the user completing a transaction with the merchant using the first portal. The method further includes providing the fulfillment to the user.

Embodiments further include a computer program product, including a non-transitory computer-readable storage medium having computer-readable program code embodied therewith, the computer-readable program code executable by one or more computer processors to perform an operation. The operation includes identifying a merchant based on a request received from a communication device associated with a user. The operation further includes searching in a communication network for portals relating to the identified merchant and identifying a plurality of portals. The operation further includes selecting a first portal, from the plurality of portals. The operation further includes initiating, by a server using at least one of the one or more computer processors, a session with the first portal, including transmitting to the first portal one or more aggregate identifiers that identify both the user and the server. The operation further includes determining that the user is entitled to a fulfillment based on the user completing a transaction with the merchant using the first portal. The operation further includes providing the fulfillment to the user.

Embodiments further include a system, including one or more computer processors, and a memory storing a program, which, when executed on the one or more computer processors, performs an operation. The operation includes identifying a merchant based on a request received from a communication device associated with a user. The operation further includes searching in a communication network for portals relating to the identified merchant and identifying a plurality of portals. The operation further includes selecting a first portal, from the plurality of portals. The operation further includes initiating, by a server using at least one of the one or more computer processors, a session with the first portal, including transmitting to the first portal one or more aggregate identifiers that identify both the user and the server. The operation further includes determining that the user is entitled to a fulfillment based on the user completing a transaction with the merchant using the first portal. The operation further includes providing the fulfillment to the user.

### Example Embodiments

Customers can buy goods or services from a merchant over the Internet using a web browser, software program, mobile application, or other application. Customers can shop online using a variety of different electronic devices, including mobile phones, tablet computers, laptop computers, and desktop computers. A customer can purchase goods or services through an online purchase environment, which typically allows customers to view available products and services, select desired products or services, and purchase the products or services. A customer can complete a transaction by providing a valid method of payment, such as a payment card (e.g., credit card or debit card) or a credential for a payment service.

As discussed above, customers can use portals to receive promotions and benefits when purchasing goods and services from merchants. For example, the customer can sign up for an account with a portal and then use the portal for purchases. After the customer makes purchases through the portal, the customer will be provided with the offered benefits (e.g., cash back, miles, loyalty points, etc.) from the portal.

While this scenario has many benefits to both customers and merchants, it also has some disadvantages. For example, different portals may offer different benefits for a given merchant or for different category of items at a given merchant, or a given merchant may only offer benefits for a limited number of portals (e.g., a merchant may have a limited relationship with a portal). One portal might cater to a particular market segment and drive a large quantity of traffic to a given merchant, and thus offer 10% cash back to its customers for purchase from that merchant. Another portal might cater to a different market segment and drive a smaller quantity of traffic to the merchant, and thus offer only 5% cash back to its customers for purchases from that merchant. The portals might also vary, for example, by providing different benefits for different categories of items at a given merchant (e.g., a greater benefit for a particular item compared to other items, or for a particular category of items compared to other items), or by providing benefits for limited period of time (e.g., a day, a weekend, a week). Further, portals can vary based on the terms under which the customer receives benefits. One portal may provide the benefits more frequently than another portal (e.g., weekly instead of monthly, or monthly instead of quarterly), or may provide benefits a wider variety of formats (e.g., electronic payment formats for cash back).

This raises several challenges. A customer may not be aware of the different benefits, and so may use a portal offering an inferior benefit, resulting in a lost benefit for the customer. Or a customer may not make as large a purchase from the merchant (or may make no purchase at all) because the customer is unaware of the better benefit or preferred portal policy, resulting in lost sales for the merchant.

Further, even if a customer is aware of the differences in benefits between portals, to take advantage of the preferred benefits the customer must maintain an account at multiple portals. This is cumbersome for the customer, who must sign up for multiple different portals, remember account information across multiple different portals, remember the benefits and bonuses to which the customer is entitled, update payment and refund information across multiple different portals, etc. It may even be challenging for a customer to remember which purchases were made at which portals, to ensure the customer receives the benefits.

In addition, many portals fulfill benefits for a customer only after the customer reaches a threshold level of benefits. For example, a portal may require a customer to accrue $25 in cashback, before providing the cashback to the customer. A portal might do this, for example, to avoid transaction costs associated with fulfilling the benefit (e.g., bank or payment fees for large numbers of small payments). But a customer wishing to take advantage of preferred benefits from multiple portals will take much longer to achieve the benefit threshold for any given portal, or may never achieve the threshold at all. For example, assume that a customer makes sufficient purchases to accrue $25 in cash back. If the customer is shopping using a single portal with a $25 fulfillment threshold, this is sufficient to meet the portal's threshold, and the portal will fulfil the benefit for the customer (e.g., pay the customer the cash back). If the customer is shopping using multiple portals, however, each portal is likely to remain below its respective fulfillment threshold so that the customer must wait longer to receive the benefit to which the customer is entitled. Further, different portals may offer different ways to fulfill benefits for the customer. A given portal might offer fulfillment of cash back benefits using one payment processor, while another portal might offer fulfillment using a different payment processor.

These may be a drawback to the customer, who must wait to receive the desired benefit and may not prefer to receive benefits in the way offered by the portal. It may also be a drawback to each entity maintaining a portal, because a customer is less likely to use portals if the customer knows the customer is unlikely to meet the required threshold and actually receive the desired benefit. And it may be a drawback to merchants, because customers may make fewer purchases, in total, if the customers are less incentivized to use portals.

One or more of these drawbacks can be improved by portal search and aggregation as discussed according to one or more embodiments herein. In an embodiment, instead of (or in addition to) interacting with individual portal websites, a customer can interact with a portal aggregation service. The portal aggregation service can search for, and identify, available portals and allow the customer to interact with multiple available portals using a single account. The customer can avoid creating multiple accounts, be assured of receiving the best available benefit, can reach benefit fulfillment thresholds much more quickly, and can receive fulfilment in the customer's preferred manner. Further, the customer can receive benefits from a wide variety of merchants, regardless of the limitations of individual portals (e.g., regardless of any exclusive or limited relationships between portals and merchants).

For example, a customer can sign up for an account with the portal aggregation service. The customer can then select a desired merchant for purchases.

The portal aggregation service can search available portals, and identify the portal with the preferred benefit for the desired merchant (e.g., the largest cash back percentage, the most miles or loyalty points, etc.). Further, the portal aggregation service can notify the customer of any limitations on the benefit (e.g., a limited time period for the benefit or a limited category of items to which the benefit applies). The customer can then shop at the merchant, and the portal, through the portal aggregation service. In an embodiment, the portal aggregation service allows the customer to do this across multiple portals, securely tracing the customer's purchases through each portal and the benefits to which the customer is entitled. The portal aggregation service then fulfils the benefits when the customer reaches a threshold for the portal aggregation service, across multiple portals. In an embodiment, the portal aggregation service can offer a variety of different ways to fulfill the benefit for the customer (e.g., a variety of different payment processors or loyalty point redeemers).

As one example, assume a customer accrues $5 cash back at five different portals. Assume each portal has a $25 threshold to fulfill cash back, and the customer uses an aggregation service that also has a $25 threshold. Without using the portal aggregation service, as discussed above, the customer must maintain an account at five different portals and does not yet receive any cash back because the customer has not reached the $25 threshold at any one portal. Using the portal aggregation service, however, the customer must maintain only one account (e.g., with the portal aggregation service) and the customer receives the cash back immediately because the total cash back across all five portals meets the portal aggregation service threshold of $25. Further, in an embodiment, the customer can receive the cash back using a preferred payment processor, that may not have been offered by one (or more) of the portals.

Further, the portal aggregation service receives reimbursement for the benefit, from the portal, quickly. Because the portal aggregation service uses an account used by multiple users (e.g., thousands or millions of users) for a given portal, the portal aggregation service will rapidly reach any fulfillment threshold and be entitled to payment of the benefit, as reimbursement for the benefit paid to the user.

Thus, according to one or more embodiments described herein, using a portal aggregation service can provide a number of benefits to customers. Customers can be assured that they are receiving the best possible benefit for each retailer, because the portal aggregation service searches across portals. Customers need only maintain one account, with the portal aggregation service, rather than multiple accounts with multiple portals. And the customers receive their desired benefits (e.g., cash back) more quickly because they are accrued across multiple portals, and therefore meet any fulfillment threshold much more quickly.

Further, according to one or more embodiments described herein, using a portal aggregation service can provide numerous technical benefits. For example, an aggregation service can maintain a secure account with a number of portals, reducing the potential security risk associated with a customer maintaining multiple accounts across multiple portals. As another example, the aggregation service can reduce network traffic to internet portals by connecting from the aggregation service to a preferred portal, reducing the need for users to establish connections with multiple portals. And as another example, an aggregate identifier (as discussed below) can allow the aggregation service to identify both a customer and the aggregation service to a portal, while limiting network traffic.

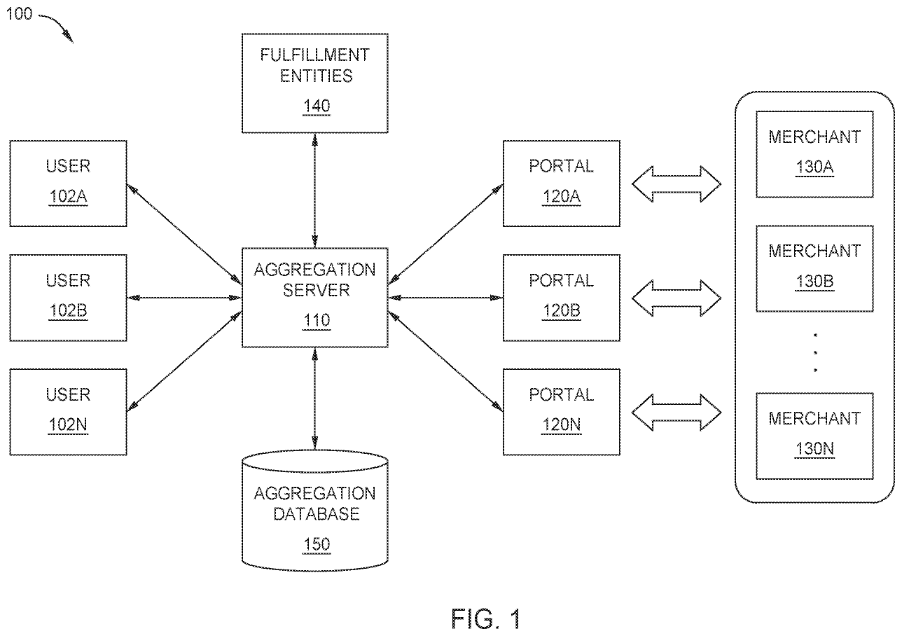

FIG. 1 illustrates a communication network 100 with portal search and aggregation, according to one embodiment. The communication network 100 includes a number of users 102A-N and a number of merchants 130A-N. In an embodiment, the users 102A-N are shoppers in an electronic commerce environment using an electronic communication device. The users can shop using any suitable communication device, including a computer, a smartphone, a tablet, or any other suitable device. In an embodiment, the users shop using a web browser, mobile application, or similar application. Further, in an embodiment, the users use a browser extension (e.g., a software component that provides extended functionality for a web browser) or a similar software component.

In an embodiment, the merchants 130A-N are electronic purchase environments (e.g., electronic storefronts) for merchants selling goods and services to the users 102A-N. Each merchant 130A-N can be an individual purchase environment (e.g., a webpage or mobile application for a particular merchant) or a multi-merchant purchase environment (e.g., a webpage or mobile application providing goods and services from multiple merchants). In an embodiment, each merchant 130A-N hosts the electronic purchase environment in a suitable electronic environment (e.g., a web server hosting a webpage acting as an electronic storefront).

The communication network 100 further includes an aggregation server 110 and a number of portals 120A-N. In an embodiment, the portals 120A-N each act as a portal for the users 102A-N to purchase goods and services from the merchants 130A-N and receive benefits and promotions based on the purchase. For example, a user 102A can use the portal 120A to purchase goods from a merchant 130A, and can receive a benefit in return (e.g., a percentage of cash back, miles, loyalty points, or any other suitable benefit).

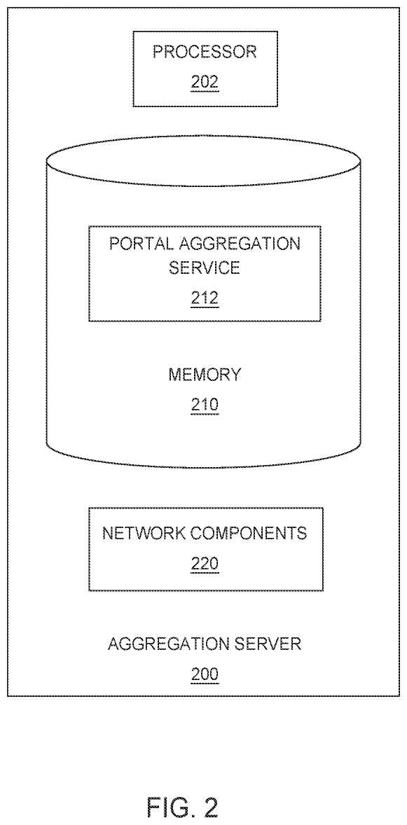

In an embodiment, the aggregation server 110 facilitates portal search and aggregation for the users 102A-N. For example, as discussed further below with regard to FIGS. 2-6, a user 102A can communicate with the aggregation server 110 in place of any of the portals 120A-N to purchase goods from a given merchant 130A. The user 102A can receive benefits offered by one or more of the portals 120A-N for purchases from the merchant 130A without interacting directly with the portals 120A-N. In an embodiment, the aggregation server 110 can identify available portals 120A-N offering benefits or promotions for purchases from the merchant 130A, and can direct any purchase by the user 102A through a desired portal 120A-N.

Further, in an embodiment, the aggregation server 110 can record purchases by the users 102A-N through the portals 120A-N using an aggregation database 150. The aggregation database 150 can be any suitable electronic database or electronic storage location, including a relational database, a non-relational database, a graph database, etc. Further, the aggregation database 150 can be a cloud storage location, a local storage location, a private remote storage location, etc. The aggregation database 150 can, for example, record that a given purchase was made by the user 102A from the merchant 130A using the portal 120A. The aggregation database can further record the benefits received by the user 102A for purchases, across different portals (e.g., the amount of cash back to which a user is entitled). The aggregation database 150A can, for example, record that the user 102A is entitled to a total of $25 cash back across two purchases: one purchase from the merchant 130A through the portal 120A entitling the user to $10 cash back, and another purchase from the merchant 130B through the portal 120B entitling the user to $15 cash back.

In an embodiment, the aggregation server 110 interacts with one or more fulfillment entities 140 to provide the promised benefits to a user. The fulfillment entities 140 can be any suitable entity to provide the benefits, including financial institutions to fulfill monetary benefits (e.g., banks, online payment entities), loyalty point providers to fulfill loyalty point benefits, merchants to fulfill gift card benefits, or airlines to fulfill airline mile benefits. For example, assume the user 102A is entitled to $25 cash back based on two purchases using the portals 120A and 120B. A bank associated with the user 102A could be one of the fulfilment entities 140, and the aggregation server 110 could interact with the bank to provide a cash back payment to the user.

As another example, the fulfillment entities 140 could include a bank associated with the aggregation server 110, and the aggregation server 110 could provide a check or other form of payment to the user 102A using the fulfillment entity. In an embodiment, as discussed further below, the aggregation server 110 is reimbursed by the portals 120A-N for benefits paid to the users 102A-N. For example, the aggregation server 110 could be reimbursed $10 from the portal 120A and $15 from the portal 1208 for a $25 cash back payment to the user 102A.

FIG. 2 is a block diagram illustrating an aggregation server 200 for portal search and aggregation, according to one embodiment. In an embodiment, the aggregation server 200 corresponds with the aggregation server 110 illustrated in FIG. 1. The aggregation server 200 includes a processor 202, a memory 210, and network components 220. The processor 202 generally retrieves and executes programming instructions stored in the memory 210. The processor 202 is representative of a single central processing unit (CPU), multiple CPUs, a single CPU having multiple processing cores, graphics processing units (GPUs) having multiple execution paths, and the like.

The network components 220 include the components necessary for the aggregation server to interface with a communication network, as discussed above in relation to FIG. 1. For example, the network components 220 can include wired, WiFi, or cellular network interface components and associated software. Although the memory 210 is shown as a single entity, the memory 210 may include one or more memory devices having blocks of memory associated with physical addresses, such as random access memory (RAM), read only memory (ROM), flash memory, or other types of volatile and/or non-volatile memory.

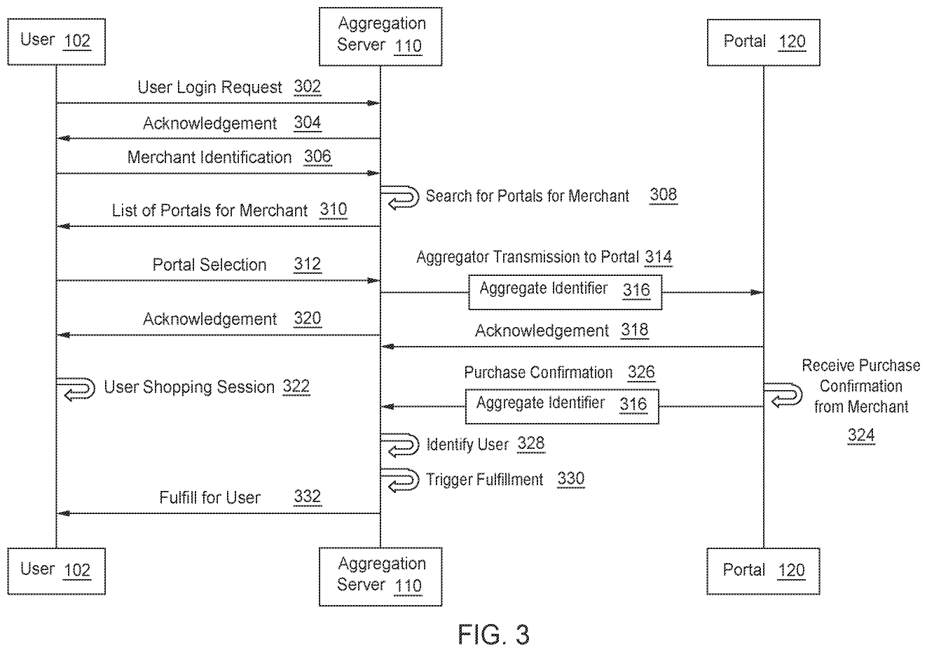

The memory 210 generally includes program code for performing various functions related to use of the aggregation server 200. The program code is generally described as various functional “applications” or “modules” within the memory 210, although alternate implementations may have different functions and/or combinations of functions. Within the memory 210, the portal aggregation service 212 facilitates portal search and aggregation. This is discussed further below with regard to FIGS. 3-6.

FIG. 3 is a message diagram for portal search and aggregation, according to one embodiment. A user 102 (e.g., one of the users 102A-N illustrated in FIG. 1) transmits one or more network messages including a user login request 302 (e.g., from a user communication device) to an aggregation server 110 (e.g., the aggregation server 200 illustrated in FIG. 2). In an embodiment, the user 102 can transmit the user login request 302 using a web browser, a mobile application, or any other suitable electronic application.

Further, in an embodiment, the aggregation server 110 maintains an account associated with the user 102. The account can include any suitable information relating to the user, including a username, a password, one or more e-mail addresses, one or more physical addresses, user preferences, user fulfillment information (e.g., financial account preferences, mileage accounts, loyalty point accounts, etc.). For example, the user 102 can be prompted to sign up for an account when first accessing the aggregation server 110. The user 102 can log in to the account using any suitable authentication or security software or protocol. In an embodiment, the user can log in to the aggregation server 110 using a social media sign-in (e.g., using an existing social media account with a social media platform like Facebook®, Instagram®, or Twitter®) or an existing third party account from another third party website (e.g., Google®, Apple®, PayPal®, Amazon®, AOL®, Yahoo®, etc.). For example, when a user 102 first visits the aggregation server 110, the user can be prompted to log in using an existing account from a social media platform or other third party website, or to create a new account. The user login request 302 can identify any type of user account.

In an embodiment, the user login request 302 includes a username and password (e.g., an encrypted password) and any other information required to log in to the aggregation server 110. A username and password are only one example of suitable login information. In an embodiment, biometric identification (e.g., fingerprint identification, facial scan information, retinal scan information, voice scan information, etc.) can be used for the user to log in to the aggregation server 110.

The aggregation server 110 responds with an acknowledgement 304. In an embodiment, the acknowledgment 304 acknowledges to the user 102 that the user 102 has successfully logged in to the aggregation server 110 (e.g., assuming the user 102 provided a correct username and password).

The user 102 then transmits a merchant identification 306 to the aggregation server 110. In an embodiment, the merchant identification 306 identifies a merchant at which the user 102 wishes to shop. For example, the aggregation server 110 can provide a list of available merchants to the user. The aggregation server 110 can, as one example, include a web server that serves a suitable webpage to the user 102 identifying available merchants. The user 102 can click on a desired merchant, triggering the merchant identification 306. In an embodiment, the aggregation server 110 can also allow the user 102 to search for a desired merchant. This is merely one example, and the user 102 can be provided with options for merchants in any suitable manner, and can select a desired merchant in any suitable manner.

Further, the user 102 need not identify a desired merchant. Instead, the user 102 could identify a desired product or service, a desired category of merchants, or a desired category of products or services, and the aggregation server 110 can identify merchants that correspond to the request. In this example, the merchant identification 306 includes identification information identifying the desired request, in place of (or in addition to) desired merchant information.

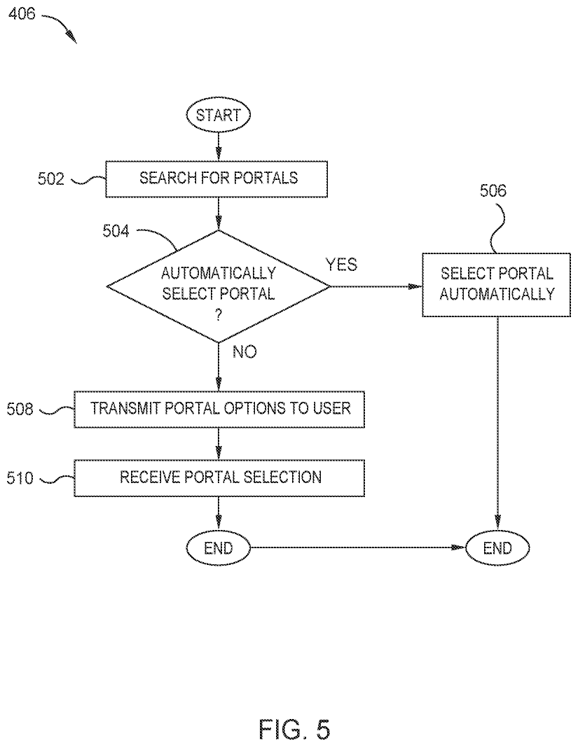

At step 308, the aggregation server 110 searches for portals for the requested merchant. In an embodiment, the merchant identification 306 identifies a merchant at which the user 102 wishes to shop. At step 308, the aggregation server 110 identifies which available portals provide a benefit or promotion for the desired merchant, and what that benefit or promotion is. For example, as discussed above, the aggregation server 110 can be configured to work with multiple different portals. Only a subset of these portals might support the requested merchant. Further, multiple portals could include varying benefits (e.g., varying quantities of cash back) for the requested merchant. In an embodiment, at step 308 the aggregation server 110 identifies both the portals that support the requested merchant and the benefit or promotion offered by each portal, for that merchant. This is discussed further with regard to FIG. 5, below.

At step 310, the aggregation server 110 then transmits a list of portals for the merchant to the user 102. As discussed above, in an embodiment, the list of portals also includes available benefits and promotions for the requested merchant from each portal. This list of portals can be provided to the user 102 in any suitable format or fashion.

In an embodiment, the user 102 then selects a desired portal from the list of portals, and at step 312 transmits a portal selection. For example, the list of portals can be provided as part of a webpage to be displayed by a web browser or mobile application used by the user 102. The user 102 can select a desired portal (e.g., using a user interface and based on the listed choice of offers) and can transmit the selection to the aggregation server 110 in step 312. In an embodiment, the list of portals can be provided in a suitable user interface providing information about the portal and available benefits.

For example, the user interface could identify limitations on benefits. This can include eligible time periods, eligible items, eligible categories of items, eligible categories of customers, or any other suitable information. The user interface could further identify characteristics of the portals, including fulfillment periods (e.g., weekly, monthly, quarterly), fulfillment options (e.g., available payment processors, gift card providers, loyalty point providers), waiting periods between completion of a transaction and fulfillment of benefits, and any other suitable characteristics.

As another example, the user interface could provide information about the relationship between the aggregation server 110 and the relevant portal. In an embodiment, the aggregation server collects a fee from the portal, or from the merchant. For example, the aggregation server could receive a percentage of any benefit allotted to the customer. Alternatively, or in addition, the aggregation server could receive a fee from the portal (e.g., a monthly fee). These differences could also be identified for the user. Further, the aggregation server could provide information about any payment required from the user. For example, the aggregation server could charge a fee to the user (e.g., a monthly fee, a percentage of transactions, a per-transaction fee). This fee could apply to some, but not all, transactions (e.g., first 10 transactions fee) or could vary across portals or transactions (e.g., a per-transaction price could drop with more transactions). These are all merely examples, and the user interface can provide any subset of this information.

As discussed above, in an embodiment the user 102 can select a desired portal and provide the portal selection to the aggregation server 110. Alternatively, the aggregation server 110 can automatically select a preferred portal for the user 102 (e.g., bypassing transmission of the list of portals and the portal selection). For example, a user 102 can automatically be provided with the portal that provides the highest percentage of cash back for a given merchant. At step 308, the aggregation server 110 searches for available portals, and benefits and promotions associated with each portal, for the requested merchant. The aggregation server 110 uses the results of this search to identify the preferred portal (e.g., the portal offering the highest amount of cash back from the desired merchant). The aggregation server then selects the preferred portal and proceeds to step 314, bypassing steps 310 and 312. This is discussed further below with regard to FIG. 5.

At step 314, the aggregation server 110 transmits a message to a portal 120. In an embodiment, the portal 120 is the portal that was either selected by a user 102 (e.g., in the portal selection at step 312) or by the aggregation server 110 (e.g., if automatic selection is preferred). In an embodiment, the aggregation server 110 transmits to the portal 120 tracking information that the portal 120 can use to identify the aggregation server 110, rather than the user 102. For example, the portal 120 can require a user to log in. If the user 102 were to use the portal 120 without the aggregation server 110, the user 102 would be required to create an account associated with the portal 120 and log in to the portal 120 using the user's account. In an embodiment, instead, the user maintains an account with the aggregation server 110 and the portal 120 associates transactions made by the user (e.g., purchases) with the aggregation server 110.

As part of step 314, the aggregation server 110 also provides an aggregate identifier 316 to the portal 120. In an embodiment, the aggregate identifier 316 both identifies the aggregation server 110 to the portal 120, and identifies the user 102 to the aggregation server 110. In an embodiment, the aggregate identifier 316 further identifies the desired merchant. The aggregate identifier 316 can be a single identifier or multiple identifiers. For example, the aggregate identifier 316 can be combination of a user identifier (e.g., a click identifier) associated with the user 102 and an aggregation server identifier associated with the aggregation server 110 (and a merchant identifier, as appropriate). The user identifier portion can be used by the aggregation server 110 to uniquely identify the user 102 (e.g., so that the aggregation server 110 can fulfill benefit requests for the correct user), and the aggregation server identifier portion can be used by the portal 120 to uniquely identify the aggregation server 110 (e.g., so that the portal 120 can notify the aggregation server of purchases). The aggregate identifier 316 can be any suitable format. For example, the aggregate identifier, or identifiers, can be a combination of hexadecimal digits, decimal digits, ascii or unicode characters, etc.

The portal 120 then transmits an acknowledgement 318 to the aggregation server 110. In an embodiment, the acknowledgment 318 notifies the aggregation server 110 that the aggregation server 110 has successfully transmitted the aggregate identifier in to the portal 120. The aggregation server 110 then, in turn, transmits an acknowledgment 320 to the user 102. In an embodiment, the acknowledgment 320 notifies the user 102 that the user 102 has successfully begun a transaction with the portal 120. For example, the user 102 can be provided with a notification indicating success. In an embodiment, the acknowledgment 320 further includes information identifying the benefits or promotions to which the user 102 is now entitled. The user 102 can further be provided with an indication of this benefit or promotion (e.g., on a webpage display in a web browser, in a mobile app, in a browser extension, etc.), and can be automatically re-directed to a storefront (e.g., a website) associated with the requested merchant.

At step 322, the user 102 initiates and completes a shopping session with the requested merchant, using the portal 120. In an embodiment, the merchant is notified at the start of the shopping session that the session is associated with the portal 120, and the merchant tracks the session and provides notification to the portal 120 when the shopping session is completed (e.g., when the user completes a purchase). This can be done, for example, by exchanging a tracking identifier between the portal 120 and the merchant. Alternatively, or in addition, an application associated with the user 102 (e.g., a web browser, a mobile application, or a browser extension) tracks the session and notifies the portal 120 when the user 102 completes the shopping session.

At step 324, the portal 120 receives purchase confirmation from the merchant. As discussed above, this purchase confirmation can come from the merchant or from the user 102. Alternatively, this purchase confirmation can come from any other suitable source. In an embodiment, the purchase confirmation includes a tracking variable identifying information about purchase (e.g., the amount of the purchase, payment method, etc.).

The portal 120 then transmits a purchase confirmation 326 to the aggregation server 110. In an embodiment, the purchase confirmation 326 includes the aggregate identifier 316. For example, the portal 120 can use the aggregate identifier 316 received earlier (e.g., received as part of the aggregation server transmission at step 314), and a tracking variable received from the merchant, to determine that the purchase confirmation received at step 324 is associated with the aggregation server 110. The portal 120 can then transmit the purchase confirmation 326 to the aggregation server 110, including the aggregate identifier 316.

At step 328 the aggregation server 110 identifies the user 102 associated with the purchase. In an embodiment, the aggregation server 110 uses the aggregate identifier 316 to identify the user 102. For example, the aggregate identifier 316 can parse the aggregate identifier to identify the user identifier, and can use the user identifier to identify the user 102. In an embodiment, the user identifier can be a plaintext value, an encoded value, an encrypted value (e.g., using public key encryption), etc. For example, the aggregation server 110 can encrypt the user identifier before generating the aggregate identifier 316. This can shield information about the user 102 from the portal 120.

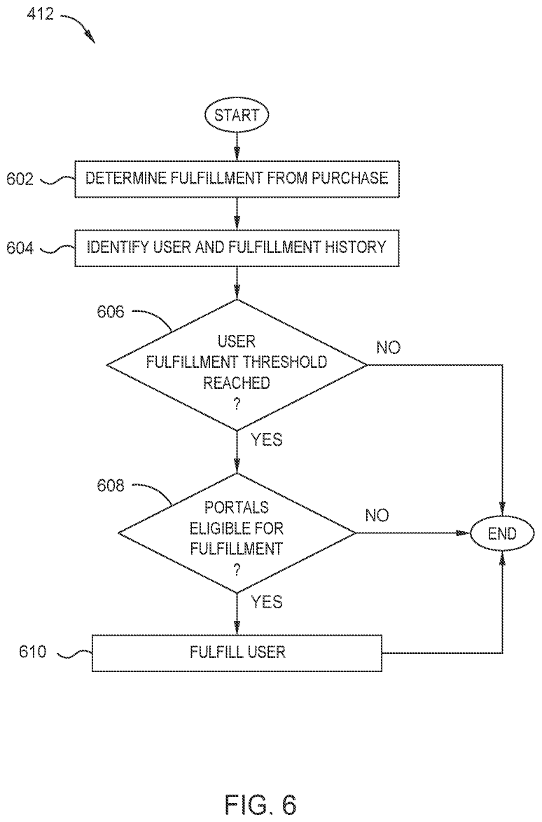

At step 330, the aggregation server 110 triggers fulfillment for the identified user. This is discussed further below with regard to FIG. 6. For example, the purchase confirmation 326 can be used to identify the benefit or promotion to which the user 102 is now entitled (e.g., an amount of cash back). The aggregation server 110 can determine whether the user is now entitled to fulfillment. For example, the aggregation server 110 can determine whether the user has now reached a cash back threshold. As another example, the aggregation server can determine whether a lock-in period has passed (e.g., a specified period of time after purchase before the user is entitled to fulfillment). As discussed further below, in an embodiment a lock-in period can be used to protect against events which might remove accrued benefits after the purchase completes (e.g., item returns, credit card disputes, or fraud reports), by providing a waiting period after a transaction and before fulfillment. If the aggregation server 110 determines that the user is entitled to fulfillment, it triggers fulfillment (e.g., generates a check, an electronic payment, a gift card, etc.). At step 332, the aggregation server 110 fulfills the benefit or promotion for the user (e.g., provides the payment, gift card, etc. to the user 102).

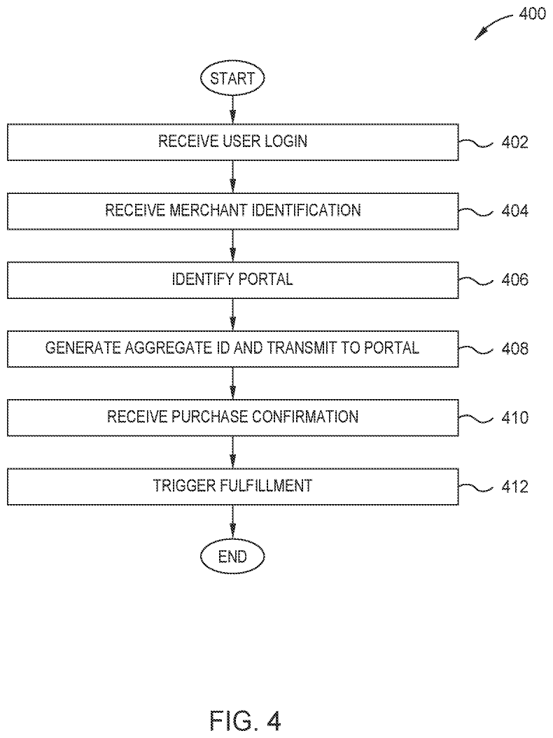

FIG. 4 is a flowchart 400 illustrating portal search and aggregation, according to one embodiment. In an embodiment, the flowchart 400 corresponds with actions taken by the aggregation server 110 illustrated in FIG. 3. At block 402 a portal aggregation service (e.g., the portal aggregation service 212 in the aggregation server 200 illustrated in FIG. 2) receives a user login. As discussed above in relation to FIG. 3, in an embodiment a user maintains an account with an aggregation server (e.g., a specific account with the aggregation server or an account with a third party website used with the aggregation server). At block 402, the portal aggregation service receives the user login information (e.g., username and password).

In an embodiment, if the portal aggregation service recognizes the user login information, the portal aggregation service logs the user in and transmits an acknowledgment to the user. If the portal aggregation service does not recognize the user login information, the portal aggregation service notifies the user and requests different login information (e.g., a different username or password) or suggests the user create an account.

At block 404, the portal aggregation service receives a merchant identification from a user. In an embodiment, the user selects a desired merchant (e.g., using a webpage, a mobile app, or another electronic application) and transmits the merchant identification to the aggregation server. The portal aggregation service uses the merchant identification to search for, and select, suitable portals for the user. As discussed above in relation to FIG. 3, merchant identification is merely one example. Alternatively, or in addition, the user could identify a desired product or service, a desired category of merchants, or any other suitable identification information. The portal aggregation service can use this identification information to search for, and select, portals for the user.

At block 406, the portal aggregation service identifies a portal for the user. In an embodiment, the portal aggregation service uses the identification information received at block 404 (e.g., merchant identification) to identify a portal for the user to use for shopping (e.g., at the identified merchant). For example, the portal aggregation service can search for suitable portal options, and can select a preferred portal based on one or more criteria, or can provide a list of options for the user to select a preferred portal. This is discussed further below with regard to FIG. 5.

At block 408, the portal aggregation service generates an aggregate ID and transmits it to the selected portal to initiate a session. In an embodiment, at block 406 the portal aggregation service identifies the portal to use for the user's shopping session. At block 408, the portal aggregation service transmits the aggregate ID to the identified portal. As discussed above in relation to FIG. 3, in an embodiment the portal aggregation service provides identification to the portal so that transactions are associated with the portal aggregation service, in addition to (or instead of) a particular user.

In an embodiment, to facilitate this the portal aggregation service generates an aggregate ID that identifies both the user and the portal aggregation service, and provides this aggregate ID to the portal. For example, as discussed above, the portal aggregation service can generate an aggregate ID made up of a combination of a user ID (e.g., a click ID associated with the user) and an aggregation service ID. In an embodiment, the aggregate ID can further include a merchant identifier. The portal aggregation service can then provide this aggregate ID to the portal. Alternatively, or in addition, the portal aggregation service can provide the portal with identifying information for the user in another suitable manner. For example, the portal aggregation service can include a user identifier in a notes field of a communication message from the portal aggregation service to the portal.

At block 410, the portal aggregation service receives purchase confirmation. In an embodiment, the portal aggregation service receives this purchase confirmation from the portal. For example, the portal can use the aggregate ID provided at block 408 to determine that a user associated with the ongoing portal aggregation service session has completed a purchase (e.g., the portal can use the user identifier portion to identify the user, and the aggregate identifier portion to identify the portal aggregation service). The portal can then provide purchase confirmation to the portal aggregation service. This is merely one example, and the portal aggregation service can receive purchase confirmation from any suitable source. For example, the portal aggregation service can receive purchase confirmation from the user.

At block 412, the portal aggregation service triggers fulfillment. For example, the portal aggregation service identifies the benefit(s) to which the user is entitled using the purchase confirmation received at block 410, determines whether the user has met a threshold for fulfillment, and if so provides the user with the benefit to which the user is entitled (e.g., provides cash back to the user). This is discussed further with regard to FIG. 6, below.

In an embodiment, the portal aggregation service further operates with portals available in multiple countries. In an embodiment, the portal aggregation service can identify portals across multiple countries, and can differentiate between the countries. For example, the portal aggregation service can provide information about the country associated with a portal when allowing a user to select a portal (e.g., as discussed above in relation to block 310 in FIG. 3). As another example, the portal aggregation server can automatically select portals that are associated with a preferred country for the user (e.g., the user's country of residence, or a preferred country selected by a user). As another example, the portal aggregation service can manage fulfillment for portals across different countries. For example, portals associated with different countries may offer different fulfillment options (e.g., payment processors, gift cards, loyalty point entities). The portal aggregation service can manage fulfillment across these different international options, allowing a user to fulfill benefits in a preferred manner.

In an embodiment, the portal aggregation service could, itself, aggregate multiple country-specific aggregators. For example, one aggregator could aggregate portals for the United States, while another could aggregate portals for the United Kingdom. The portal aggregation service could allow a user to select portals from both countries, using each of the separate aggregation services (e.g., treating each aggregator similarly to a portal, as discussed above in relation to FIGS. 3-4).

FIG. 5 is a flowchart illustrating identifying portals for portal search and aggregation, according to one embodiment. In an embodiment, FIG. 5 corresponds with block 406 illustrated in FIG. 4. At block 502 a portal aggregation service (e.g., the portal aggregation service 212 in the aggregation server 200 illustrated in FIG. 2) searches for available portals. In an embodiment, the portal aggregation service can access a data feed of benefit and promotion information from known portals.

For example, the portal aggregation service can maintain a list of portals and generate a list of supported merchants and offered benefits or promotions. The portal aggregation service can be provided with a listing of supported merchants and offered benefits or promotions for each portal. This listing could be provided by a portal to the portal aggregation service (e.g., to encourage the aggregation service to support the portal), could be retrieved by the portal aggregation service from the portal (e.g., using a suitable application programming interface (API)), or could be provided in any other suitable manner. Alternatively, or in addition, the portal aggregation service could be provided with a list of available portals supporting aggregation. The portal aggregation service can then spider the list of available portals and gather data about merchants supported and benefits and promotions offered. In an embodiment, the portal aggregation service can do this intermittently (e.g., every few seconds or every few minutes), on demand, or both. The portal aggregation service can search the list of available portals and merchants to identify benefits and promotions offered by a given portal for a given merchant. This search can be performed using any suitable search technique.

In an embodiment, a given portal may offer multiple benefits or promotions for a given merchant (e.g., different levels of cash back on different purchases, different benefits at different time periods, different benefits depending on user characteristics, etc.) In an embodiment, the portal aggregation service can record all available benefits or promotions, for a given portal-merchant pairing. Alternatively, the portal aggregation service can record only a preferred benefit or promotion, for a given portal-merchant pairing (e.g., a highest amount of cash back).

The portal aggregation service can maintain a listing of portals and offered benefits or promotions in any suitable location accessible to the aggregation server (e.g., a local storage, a remote database, a cloud storage, etc.). In an embodiment, the portal aggregation service can maintain the listing of portals and offered benefits or promotions for any suitable length of time. For example, the portal aggregation service can maintain the list in persistent storage and update the list periodically. As another example, the portal aggregation service can maintain the list in cache memory or other suitable shorter-term memory, and can mark the list as expired after a given duration. In this example, the portal aggregation service can re-generate an expired list as required (e.g., by querying available portals for offered benefits and promotions).

Alternatively, or in addition, the portal aggregation service can search for portals for merchants using an on-demand search. For example, the portal aggregation service can be provided with a listing of available portals, and can query each portal for support for the requested merchant (e.g., transmitting a query to the portal using a suitable API), and available benefits and promotions for the requested merchant, after receiving a merchant identification. The portal aggregation service can generate a list of portal options, for the requested merchant, to provide to a user. Alternatively, or in addition, the portal aggregation service can search for available portals without receiving a listing of available portals. For example, the portal aggregation service can use a suitable search engine to identify candidate portals, and can use queries to the portal (e.g., to a specified API) to determine whether the portal supports aggregation.

Further, in an embodiment, the portal aggregation service can maintain the listing of available portals and available benefits and promotions, for a given merchant, in a memory (e.g., a cache memory) for a limited duration of time. This relieves the processing burden on the aggregation server, when faced with a large number of requests, by maintaining a listing of portals for popular merchants in memory (e.g., in cache memory) so that the list is not repeatedly regenerated. This also limits memory usage, by only maintaining information in memory for frequently requested merchants, rather than maintaining information for all available portals and merchants (e.g., as discussed above).

At block 504, the portal aggregation service determines whether automatic portal selection is enabled. In an embodiment, the portal aggregation service can provide a listing of portal options to a user, and allow the user to select a desired portal. Alternatively, or in addition, the portal aggregation service can automatically select a portal for the user to use. This can be configured by a user and associated with a user's account information, or selected by a user when selecting a merchant. For example, a user could configure this when creating the user's account. As another example, the user could be provided with a user interface (e.g., a webpage or a mobile application) that includes a graphical trigger for automatic portal selection and another graphical trigger for user-driven portal selection, and could choose a preference, using the user interface, when selecting a desired merchant. If automatic portal selection is enabled, the flow proceeds to block 506.

At block 506, the portal aggregation service selects a portal automatically (e.g., from the available portal options identified at block 502). In an embodiment, the portal aggregation service can use one or more criteria to automatically select a portal. These criteria can be provided from any suitable source, including being provided by the user, provided to the portal aggregation service by default, or generated automatically (e.g., using machine learning).

For example, the portal aggregation service can select a portal based on popularity from other users. In an embodiment, the portal aggregation service can record which portal(s) are most popular (e.g., for a given merchant, across all merchants, for a given time period, for a given merchant category). The portal aggregation service can automatically select the portal based on this popularity. Alternatively, or in addition, the portal aggregation service can select a portal based on user ratings and reviews (e.g., favoring better rated or reviewed portals, or requiring a threshold level of rating before selecting a portal).

As another example, a user could provide criteria to assist the portal aggregation service with automatically selecting a portal. A user could specify that the user prefers a particular type of purchase (e.g., sale items, a particular category of item, items with free shipping only, etc.) or a particular type of benefit or promotion (e.g., cash back, miles, loyalty points, etc.). The user can further specify thresholds for portal ratings and reviews (e.g., requiring a certain number of stars in a star rating, a certain rating score, or a minimum number of reviews) or portal popularity (e.g., requiring a portal to be in the top 10 in popularity, or the top 10%). The portal aggregation service can record this preference (e.g., associated with the user's account information) and can use the preference to identify a preferred portal, from available portals for a given merchant, based on the benefits or promotions offered by the portal.

Alternatively, or in addition, the portal aggregation service could be configured with default criteria (e.g., select the highest available cash back). Further, the portal aggregation service can convert non-monetary benefits (e.g., miles or loyalty points) to their approximate monetary value. For example, the portal aggregation service could do this conversion based on a formula correlating the non-monetary benefit with a cash value. The portal aggregation service can then select the portal providing the highest cash back, or cash back equivalent, value. In an embodiment, this can further be based on user preferences. For example, a user could prefer a particular fulfillment entity (e.g., an airline or loyalty point provider), and could set a threshold at which the user would prefer to receive fulfillment from that entity (e.g., miles from that airline or loyalty points from that provider). If the conversion formula meets the user threshold, the portal aggregation service uses that fulfillment entity (e.g., provides the benefit as the preferred miles or loyalty points). In an embodiment, the user can set different thresholds for different entities (e.g., different thresholds for different airlines).

As another alternative, the criteria can be generated automatically. For example, a suitable machine learning model (e.g., a deep learning model) could be trained with training data. The training data could, for example, include labeled data reflecting user preferences for portals for particular categories of users and particular merchants. The trained machine learning model could then be provided with the portal options, user information, and any other relevant information (e.g., the desired merchant) and could infer a preferred portal for the user.

Returning to block 504, if automatic portal selection is not enabled the flow proceeds to block 508. At block 508, the portal aggregation service transmits portal options to the user. For example, the portal aggregation service can transmit a listing of the available portals found at block 502. This listing can be presented to the user using any suitable user interface (e.g., a webpage or a mobile application). This is discussed further, above, in relation to step 310 in FIG. 3.

At block 510, the portal aggregation service receives a portal selection from the user. For example, the user can select a desired portal from a listing of available options, using a suitable user interface. This is discussed further, above, in relation to step 312 in FIG. 3

FIG. 6 is a flowchart illustrating triggering fulfillment for portal search and aggregation, according to one embodiment. In an embodiment, FIG. 6 corresponds with block 412 illustrated in FIG. 4. At block 602 a portal aggregation service (e.g., the portal aggregation service 212 in the aggregation server 200 illustrated in FIG. 2) determines the fulfillment from a completed purchase (e.g., the purchase confirmed at block 410 illustrated in FIG. 4). For example, portal aggregation service can parse the purchase confirmation and identify the amount of a purchase by the user and the benefit (e.g., quantity of cash back, quantity of airline miles or hotel miles, etc.) to which the user is entitled, from the completed purchase. As another example, the portal aggregation service can interact with the portal using a suitable API and can receive the fulfillment information through the API.

At block 604, the portal aggregation service identifies the user and a fulfillment history for that user. In an embodiment, as described above, a user may only be entitled to fulfillment after reaching a fulfillment threshold. For example, the portal aggregation service may only provide cash back to the user after the user has accrued a threshold quantity of cash back to which the user is entitled (e.g., $25). This can reduce transaction costs associated with providing the user cash back.

At block 604, the portal aggregation service can identify both the user and a fulfillment history for the user that includes fulfillments that have not yet been provided to the user (e.g., because the user has not yet reached the required threshold). In an embodiment, this information can be stored in any suitable database or storage location (e.g., the aggregation database 150 illustrated in FIG. 1). The portal aggregation service can identify the user based on a purchase confirmation received from a portal (e.g., using an aggregate identifier) or using any other suitable technique. This is discussed in more detail above, with regard to step 328 illustrated in FIG. 3.

At block 606, the portal aggregation service determines whether the user fulfillment threshold has been reached. For example, the fulfillment from the user's latest purchase may bring the user above the required fulfillment threshold. The portal aggregation service could, for example, determine at block 604 that the user has $20 in pending cash back and determine at block 602 that the current transaction entitles the user to an additional $6 of cash back. At block 606, the portal aggregation service could determine that the fulfillment threshold is $25, the user is now entitled to $26, and so the user should be fulfilled. In an embodiment, the fulfillment threshold can vary based on user history. For example, more frequent users, or users with a longer history of purchases, may be entitled to fulfillment at a lower threshold than newer (or less trusted) users.

Further, the portal aggregation service can, in an embodiment, determine whether sufficient time has passed to lock in payment of the benefits. In an embodiment, a user must wait for a specified duration (e.g., 60 days) before receiving benefits (e.g., cash back) to ensure that the user does not return the purchased item. The portal aggregation service can further determine whether the required duration has passed, for the current transaction and historical transactions. The lock-in period can also vary based on user history, as discussed above (e.g., more frequent users can have a shorter lock-in period). In an embodiment, if the user fulfillment threshold is not reached, or the lock-in period has not expired, the flow ends.

If the user fulfillment threshold is reached, the flow proceeds to block 608. At block 608, the portal aggregation service determines whether the portal is eligible for fulfillment to the user. In an embodiment, the portal aggregation service fulfills a user by providing a benefit to the user (e.g., cash back). The portal aggregation service is, in turn, reimbursed by the portal for this benefit. For example, assume a user is entitled to $25 total cash back, based on $5 in cash back from each of five different portals. The portal aggregation service can fulfill the user by providing that $25 cash back payment, and in turn receive $5 from each of the five portals as reimbursement.

Different portals, however, have different policies on when benefits are paid out. Some portals may pay cash back out monthly, others weekly, and still others quarterly. Further, the portal aggregation service may have different levels of trust that it will be reimbursed by a given portal. The portal aggregation service may fully trust a portal with which the portal aggregation service has a long-term relationship or that is backed by a large entity, while the portal aggregation service may have less trust in a newer portal that is backed by a smaller entity.

At block 608, the portal aggregation service can determine whether it has sufficient confidence in each portal to fulfill the user. For example, the portal aggregation service could fulfill a user immediately for transactions with a trusted portal. The portal aggregation service could wait longer (e.g., until the portal aggregation service itself receives reimbursement) before fulfilling a user for transactions with an untrusted portal. If the portals are not eligible for fulfillment to the user, the flow ends.

If the portals are eligible for fulfillment, the flow proceeds to block 610. At block 610 the portal aggregation service fulfills the user. In an embodiment, the portal aggregation service provides the user with the benefit(s) to which the user is entitled. For example, the portal aggregation service can provide a payment check to the user for cash back, can make an electronic payment to an account provided by the user, can provide a gift card to the user, can provide miles or loyalty points to a user, or can provide any other suitable benefit to which the user is entitled.

In an embodiment, the user can select a preferred method of fulfillment. For example, a user can specify a preferred airline (or loyalty point provider), and can select a preference for fulfillment by frequent flyer miles from this airline (or loyalty points from this provider). In an embodiment, the portal aggregation service can use cash back values to which a user is entitled to purchase equivalent miles or loyalty points from the user's preferred provider. For example, this could be an available preference for a user. As another example, a fulfillment entity (e.g., an airline, loyalty point provider, or gift card provider) could offer a beneficial conversion ratio to the portal aggregator, and the portal aggregation service could offer this to the user (e.g., a particular airline could offer bonus miles to the user for fulfillment using that airline's miles, and that bonus offer could be provided to the user as a choice for fulfillment). In an embodiment, the user can provide account information associated with the fulfillment entity (e.g., frequent flyer number, loyalty point numbers) and the portal aggregation service can automatically apply to the fulfillment to the user's account.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
identifying a merchant based on a request received from a communication device associated with a user;
searching in a communication network for portals relating to the identified merchant and identifying a plurality of portals;
selecting a first portal, from the plurality of portals;
initiating, by a server using a computer processor, a session with the first portal, comprising transmitting to the first portal one or more aggregate identifiers that identify both the user and the server;
determining that the user is entitled to a fulfillment based on the user completing a transaction with the merchant using the first portal; and
providing the fulfillment to the user.

2. The method of claim 1, wherein determining that the user is entitled to the fulfillment further comprises:
receiving, at the server, one or more network messages indicating that the user completed the transaction, wherein the one or more network messages are provided to the server based on the one or more aggregate identifiers.

3. The method of claim 2, further comprising:
identifying the user based on the received one or more network messages;
retrieving a fulfillment history relating to the user from an electronic storage; and
determining that the user meets a fulfillment threshold based on the one or more network messages and the fulfillment history.

4. The method of claim 3, wherein the fulfillment history comprises a second fulfillment relating to a second portal, different from the first portal, and wherein determining that the user meets the fulfillment threshold comprises determining that the fulfillment and the second fulfillment, combined, meet the fulfillment threshold.

5. The method of claim 1, wherein providing the fulfillment to the user comprises selecting a fulfillment entity for the fulfillment.

6. The method of claim 5, wherein selecting the selecting the fulfillment entity is based on a user input.

7. The method of claim 5, wherein the selected fulfillment entity is not supported by the first portal.

8. The method of claim 1, wherein the one or more aggregate identifiers comprise a single aggregate identifier identifying both the user and the server.

9. The method of claim 8, wherein the single aggregate identifier comprises a click identifier received from the communication device.

10. The method of claim 1, wherein selecting the first portal comprises automatically selecting the first portal from the plurality of portals based on at least one of: (i) a popularity of the first portal to one or more other users, (ii) one or more ratings of the first portal, or (iii) or one or more reviews of the first portal.

11. The method of claim 1, wherein selecting the first portal comprises automatically selecting the first portal from the plurality of portals based on a criteria relating to a benefit or discount offered by the first portal for the merchant.

12. The method of claim 11, wherein the criteria is selected by the user.

13. The method of claim 1, wherein selecting, at the server, the first portal comprises:
transmitting to the communication device a first one or more network messages identifying the plurality of portals; and
receiving from the communication device a second one or more network messages identifying the selected first portal, wherein the first portal is selected by the user using a user interface on the communication device.

14. A computer program product, comprising:
a non-transitory computer-readable storage medium having computer-readable program code embodied therewith, the computer-readable program code executable by one or more computer processors to perform an operation, the operation comprising:
identifying a merchant based on a request received from a communication device associated with a user;
searching in a communication network for portals relating to the identified merchant and identifying a plurality of portals;
selecting a first portal, from the plurality of portals;
initiating, by a server using at least one of the one or more computer processors, a session with the first portal, comprising transmitting to the first portal one or more aggregate identifiers that identify both the user and the server;
determining that the user is entitled to a fulfillment based on the user completing a transaction with the merchant using the first portal; and
providing the fulfillment to the user.

15. The computer program product of claim 14, wherein determining that the user is entitled to the fulfillment further comprises:
receiving, at the server, one or more network messages indicating that the user completed the transaction, wherein the one or more network messages are provided to the server based on the one or more aggregate identifiers.

16. The computer program product of claim 15, the operation further comprising:
identifying the user based on the received one or more network messages;
retrieving a fulfillment history relating to the user from an electronic storage; and
determining that the user meets a fulfillment threshold based on the one or more network messages and the fulfillment history.

17. The computer program product of claim 16, wherein the fulfillment history comprises a second fulfillment relating to a second portal, different from the first portal, and wherein determining that the user meets the fulfillment threshold comprises determining that the fulfillment and the second fulfillment, combined, meet the fulfillment threshold.

18. The computer program product of claim 14, wherein selecting the first portal comprises automatically selecting the first portal from the plurality of portals based on at least one of: (i) a popularity of the first portal to one or more other users, (ii) one or more ratings of the first portal, (iii) or one or more reviews of the first portal, or (iv) a criteria relating to a benefit or discount offered by the first portal for the merchant.

19. The computer program product of claim 14, wherein providing the fulfillment to the user comprises selecting a fulfillment entity for the fulfillment and wherein the selected fulfillment entity is not supported by the first portal.

20. The computer program product of claim 14, wherein the one or more aggregate identifiers comprise a single aggregate identifier identifying both the user and the server and wherein the single aggregate identifier comprises a click identifier received from the communication device.

21. A system, comprising:
one or more computer processors; and
a memory storing a program, which, when executed on the one or more computer processors, performs an operation, the operation comprising:
identifying a merchant based on a request received from a communication device associated with a user;
searching in a communication network for portals relating to the identified merchant and identifying a plurality of portals;
selecting a first portal, from the plurality of portals;
initiating, by a server using at least one of the one or more computer processors, a session with the first portal, comprising transmitting to the first portal one or more aggregate identifiers that identify both the user and the server;
determining that the user is entitled to a fulfillment based on the user completing a transaction with the merchant using the first portal; and
providing the fulfillment to the user.

22. The system of claim 21, wherein determining that the user is entitled to the fulfillment further comprises:
receiving, at the server, one or more network messages indicating that the user completed the transaction, wherein the one or more network messages are provided to the server based on the one or more aggregate identifiers.

23. The system of claim 22, the operation further comprising:
identifying the user based on the received one or more network messages;
retrieving a fulfillment history relating to the user from an electronic storage; and
determining that the user meets a fulfillment threshold based on the one or more network messages and the fulfillment history.

24. The system of claim 23, wherein the fulfillment history comprises a second fulfillment relating to a second portal, different from the first portal, and wherein determining that the user meets the fulfillment threshold comprises determining that the fulfillment and the second fulfillment, combined, meet the fulfillment threshold.

25. The system of claim 21, wherein selecting the first portal comprises automatically selecting the first portal from the plurality of portals based on at least one of: (i) a popularity of the first portal to one or more other users, (ii) one or more ratings of the first portal, (iii) or one or more reviews of the first portal, or (iv) a criteria relating to a benefit or discount offered by the first portal for the merchant.

26. The system of claim 21, wherein selecting, at the server, the first portal comprises:
transmitting to the communication device a first one or more network messages identifying the plurality of portals; and
receiving from the communication device a second one or more network messages identifying the selected first portal, wherein the first portal is selected by the user using a user interface on the communication device.

27. The system of claim 21, wherein providing the fulfillment to the user comprises selecting a fulfillment entity for the fulfillment and wherein the selected fulfillment entity is not supported by the first portal.

28. The system of claim 21, wherein the one or more aggregate identifiers comprise a single aggregate identifier identifying both the user and the server and wherein the single aggregate identifier comprises a click identifier received from the communication device.
